(19) United States
(12) Patent Application Publication
(10) Pub. No.: US 2015/0314309 A1
(43) Pub. Date: Nov. 5, 2015

(54) Assembly for Dispensing an Adhesive Material

(71) Applicant: George Abbale, Northport, NY (US)

(72) Inventor: George Abbale, Northport, NY (US)

(21) Appl. No.: 14/267,912

(22) Filed: May 2, 2014

(51) Int. Cl. B05B 7/04; B05B 15/06; B05B 7/24

(52) U.S. Cl. CPC B05B 7/0408; B05B 7/24; B05B 15/06

(57) ABSTRACT

An assembly is provided for the controlled delivery of a two-component adhesive material that is moisture-labile, having a power supply powering a two-chambered pump for the metered delivery of the adhesive and a delivery gun for mixing the two-components at the point of delivery. In order to enable exposure to ambient, moisture-laden air while using large drums of adhesive material, at least one dual-apertured, desiccant cannister is provided sealably interfaced at an intake port on each of the drums A second aperture is provided on the desiccant cannister which is open to such ambient air. The second aperture is of a diameter sufficient to provide the influx of a necessary volume of air through the cannister(s) to accommodate the synchronized delivery of the two-component adhesive through the delivery gun. The desiccant is preferably calcium sulfate. Cobalt chloride is added to show a color change when the desiccant is saturated to enable recharge and/or replacement. The diameter of the aperture is between 0.325 and 0.4 inches, and preferably 0.37 inches to enable uniform flow through the gun.18

### CONTINUING DATA/CROSS-REFERENCE TO RELATED PROVISIONAL

This application claims the benefit of the common subject matter, content and earlier filing date of U.S. Provisional Application No. 61/817,936, pursuant to 35 U.S.C. §119(e).

### FIELD OF THE INVENTION

The present invention relates to the field of dispensation of two-component adhesives, and more particularly to portable systems for application of such adhesives on demand in a manner that avoids exposure to moisture-laden air prior to the point of application and intended curing.

### BACKGROUND OF THE INVENTION

Two component adhesives, generally urethanes, are employed routinely in roofing, flooring and carpeting applications. While the materials are made available in 15 gallon drums, the use of such drums has proven problematic. Key to the problem is that these materials are largely moisture-labile, and thus moisture in ambient are causes the chemical structure to change and, at times, polymerization to either commence or be delayed. Such two-component materials also need to be “metered,” that is, they need to be produced in the same quantities at the same time and in the location where they are to be employed.

In the past, where large applications required use of large quantities, materials were pored together and swabbed at the point of use. Obviously, quantities varied and thus the quality of the resultant adhesives changed. This causes issues not just with workmanship but with liability, as the manufacturers of the materials will not absorb warranty claims where the materials are not properly mixed and dispensed in a metered 1;1 manner

Portable systems like the “pace cart” sold by OMG Roofing Products have overtaken the field. In particular, these systems employ a “bag in a box” design, in which the bag reduces in volume as its contents are pumped out. In this manner, the materials are virtually never exposed to ambient air, and thus the moisture issues are avoided, and as well, the metering is simply to accomplish. '

However, such systems have a number of drawbacks. Notably, the “bag in a box” design is expensive and the quantity of materials is smaller (generally 5 gallons). OMG claims that its cart is protected by a number of patents, each one of which depends consistently upon the use of the “bag in a box” design, and thus obliges the purchase of such materials from that company repeatedly.

It is thus an object of the instant invention to enable the use of large vessels of dual-component materials, larger than the limiting 5 gallons heretofore employed.

It is a further object of the instant invention to enable the exposure of such materials to ambient, moisture-laden air without compromising the quality of those materials or voiding the manufacturers warranties.

It is a still further object of the instant invention to enable a retrofitting of the existing “cart” designs to optimize the use of components from such carts while enabling the employment of larger vessels of materials, and without any compromise in the quality of such materials.

### SUMMARY OF THE INVENTION

The various features of novelty which characterize the invention are pointed out with particularity in the claims annexed to and forming a part of the disclosure. For a better understanding of the invention, its operating advantages, and specific objects attained by its use, reference should be had to the drawings and descriptive matter in which there are illustrated and described preferred embodiments of the invention.

The foregoing objects and other objects of the invention are achieved through an assembly for the controlled delivery of a two-component adhesive material that is moisture-labile, having a power supply powering a two-chambered pump for the metered delivery of the adhesive and a delivery gun for mixing the two-components at the point of delivery. In order to enable exposure to ambient, moisture-laden air while using large drums of adhesive material, at least one dual-apertured, desiccant cannister is provided sealably interfaced at an intake port on each of the drums A second aperture is provided on the desiccant cannister which is open to such ambient air. The second aperture is of a diameter sufficient to provide the influx of a necessary volume of air through the cannister(s) to accommodate the synchronized delivery of the two-component adhesive through the delivery gun. The desiccant is preferably calcium sulfate. Cobalt chloride is added to show a color change when the desiccant is saturated to enable recharge and/or replacement. The diameter of the aperture is between 0.325 and 0.4 inches, and preferably 0.37 inches to enable uniform flow through the gun.

Other features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings, wherein similar reference characters denote similar elements through the several views:

FIG. 1 is a perspective view of the components of a preferred embodiment of the subject invention enabling comprehension of the invention by one of ordinary skill in the art;

FIG. 2 is a disclosure of the prior art embodiment over which the subject invention demonstrates a significant improvement;

FIG. 3 is a close-up view of the desiccant chamber and aperture dimensions important to provide sufficient airflow to enable metered delivery of the two-component adhesive, in accordance with a preferred embodiment of the subject invention; and

FIG. 4 is a dimensional view of an alternative embodiment including a heating element array on at least one of the drums containing at least one of the components.

### DETAILED DESCRIPTION OF THE PREFERRED EMBODIMENTS

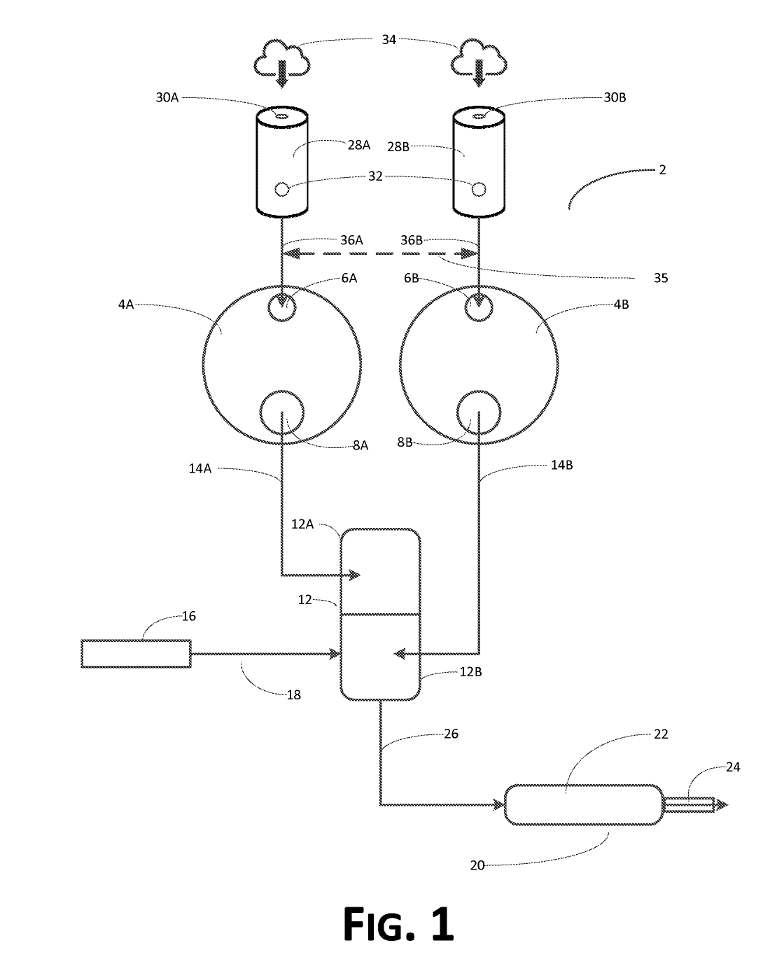

In accordance with the subject invention, FIG. 1 shows a structural view of apparatus 2, wherein component A of a two-component adhesive, preferably a urethane is contained in drum 4A and component B in drum 4B. It is understood by one of ordinary skill, that such adhesives are moisture labile and curing occurs when both components are introduced to one another (as in through gun 20) via a metering block 22 and a mixing tip 24 (which is generally of a honeycomb design such that each of the components mixes through the tip and is mixed, and commences curing at the point of delivery, and at the end of the tip).

In specific, drums 4A/B generally contain 15 gallons of each of the components of the adhesive. It should be appreciated that this amount is greater than the heretofore known “bag in a box” design” which contains less than such gallonage, and thus obliges more frequent replacement. It should be further appreciated that while drums are shown, any vessel will function, if configured in accordance with the subject invention. Drums 4A/B have two ports, port 6A which is used for ambient air, and port 6B which permits material flow.

As shown, in line with the material flow ports 6 is a tandem styled pump 12, which contains chambers 12A (correlating with the component in drum 4A) and chamber 12B (correlating with the component in drum 4B). Drums 4A/B are connected by tubing to each respective chamber of pump 12A/B, to maintain isolation of the components. Pump 12 is gerotor and gear-driven, positive displacement, rotary pump, which permits dispensing of the two component adhesive in a 1:1 ratio. Pump 12 is electrically operated via power supply 16 and wiring 18.

The output line 26 of pump 12 remains dual-tubed. In other words, each of the components of the adhesive remain isolated, mixing only when these components reach the honeycomb of tip 24, after passing through metering block 22 of gun 20.

As pump 12 creates pressure, the volume of materials in drums 4A/B are driven through the system from drums 4A/B, through tubing 14A/B, through pump 12A/B, through line 26 and to gun 20.

As pump 12 is engaged and pressure commences, ambient air is drawn into apertures 6A/B. Apertures 6A/B are sealingly and tubularly connected (through flexible tubing or fixed piping) to desiccant containers 28A/B. It should be appreciated that while there are shown two separate desiccant cannister 28A/B in FIG. 1, the apparatus will function with a single desiccant cannister (and a “y” configuration, as shown by dotted line 35, in FIG. 1). Two separate cannisters are the preferred embodiment, however, as this provides uniformity, simplicity and consistency in the field.

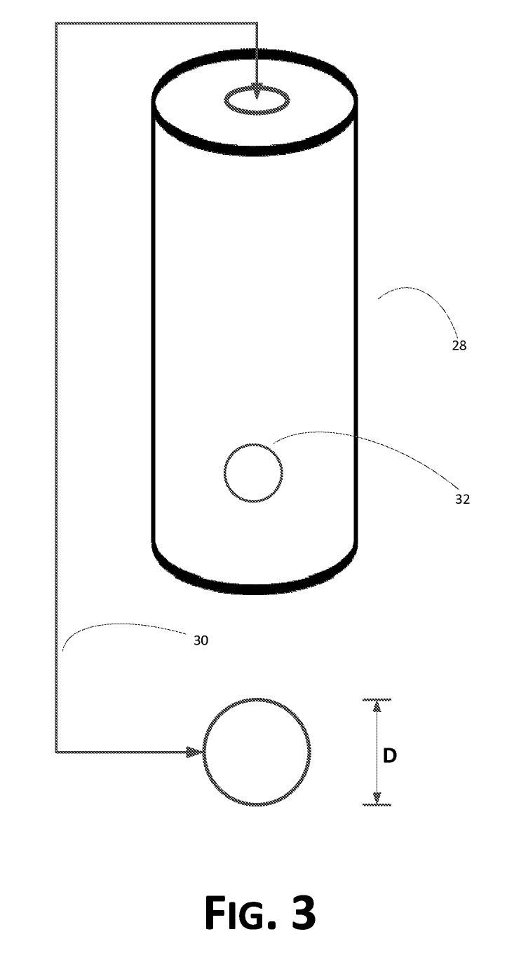

Desiccant containers 28A/B are provided with in-line apertures 30A/B of a specific diameter to enable sufficient airflow so that the apparatus has a uniform flow rate at the point of discharge through tip 24. To be sure, as pump 12 builds pressure and the volume of materials in drums 4A/B is urged through tubing 14A/B that volume must be replaced in accordance with the subject invention with ambient air. Thus, the single point of flow restriction in the system is defined by the size of apertures 30A/B, which, as shown in FIG. 3 are circular and of a diameter “D” which, in accordance with the preferred embodiment of the subject invention, is defined as 0.325 to 0.4 inches, and preferably 0.37 inches per cannister. It should be appreciate that where only one such cannister is employed, the dimensions will be approximately twice those indicated.

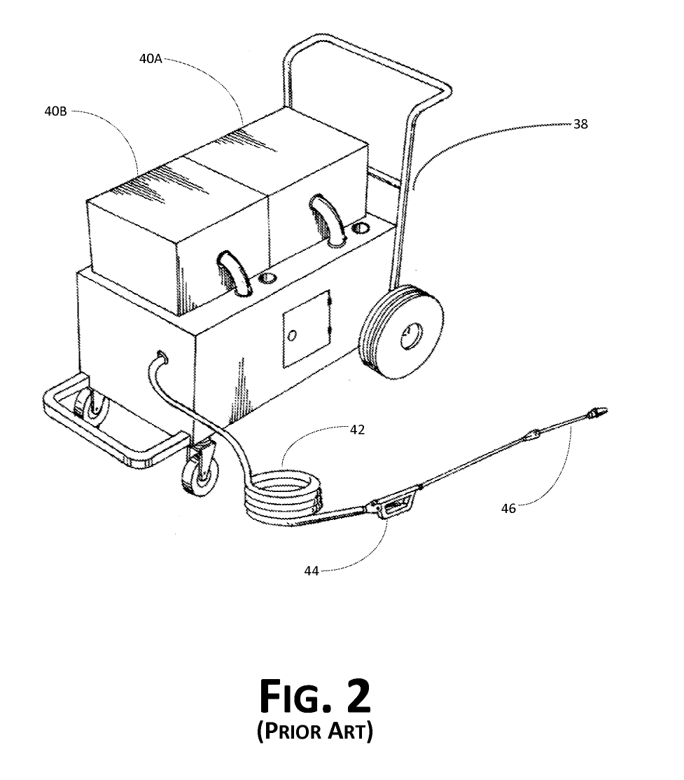

FIG. 2 shows an overview of the prior art design of a “pace cart” as sold by “OMG Roofing Products.” This device requires the use of a “bag in a box” design, as shown by boxes 40A/B, for each of the two components of the adhesive material. These “bag in a box” designs are intended to avoid the influx of ambient air, and thus overcome the issue of moisture lability of the adhesive material. As the pump creates pressure the volume in the bag is reduced, and the bag is in the boxes 40A/B. As shown, however, this design obliges the use of“bag in a box” containers which are expensive in fabrication and contain 5 gallons of material, significantly less volume than 15 gallon drums. It should be appreciated that the “pace cart” shown in FIG. 2 can be retrofitted with the subject invention, thereby taking advantage of the components already in place on the “pace cart.” However, ordinary 15 gallon drums are employed, and the risk of exposure to moisture in air—which results in decomposition of at least one component of the adhesive or premature curing—is eliminated by the specific employment of desiccant materials contained in canisters 28A/B, as shown in FIG. 1. As indicated, these canisters possess a specific aperture for the entry of ambient, moisture-laden, of a specific diameter in order to enable proper flow rates.

It should be appreciated, further, that drums 4A/B are placed in a metal (preferably steel) array upon the frame of the “pace cart” as shown in FIG. 2. This array also provides a gravity-assisted feed (as the center of gravity is raised above the point of delivery of gun 44 through tip 46. Thus, in a retrofit assembly, the efficiencies of pump 12 are enhanced by the gravity feed (and further by capillary action of the material) in a retrofitted assembly.

Canisters 28A/B are configured, in accordance with another preferred embodiment, with a site glass 32, as shown in FIG. 1. The desiccant material employed is preferably calcium sulfate, which is “rechargeable” by heat. In other words, it can be re-dried and re-used. It has been found to be an effective “water-grabber” as ambient air 34 is driven through aperture 30A/B and through the desiccant in canisters 28A/B. Adding a “color changing” material, specifically cobalt sulfate, to the desiccant contained in canisters 28A/B is part of a still other, preferred embodiment, as this material changes color as it reaches water-vapor saturation and thus will indicate when the apparatus is in use the need to replace the desiccant cartridge and/or recharge the desiccant contained in that canister.

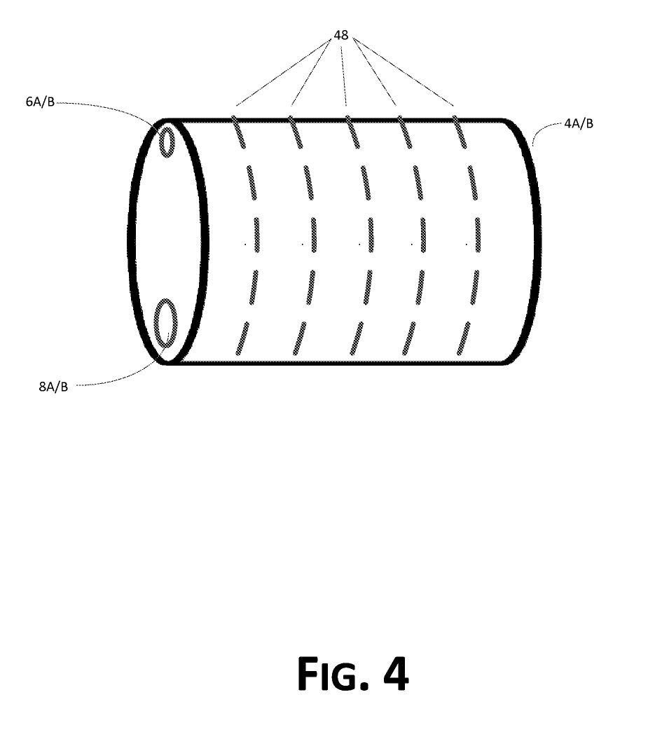

Lastly, flow rates of the dual-component adhesive materials relate to temperature. Thus, it is difficult to apply the materials consistently when the temperature drops below a certain level. Maintenance of proper temperature of drums 4A/B also correlates with moisture. Moisture builds inside of such drums at certain higher temperatures. In both instances, the quality and curability of the materials contained therein is negatively effected. Thus, in FIG. 4 there are shown heating elements 48 which can be included in an electric blanket of mylar or other material, and powered by power supply 16 (see FIG. 1) and, as well, equipped with a thermostat (not shown).

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

I claim:

1. An apparatus for dispensing a two-component adhesive, comprising:
(a) two containment vessels for containing each of the components in isolation from one another, each such vessel comprising an air intake port and a material output port;
(b) at least one dual-apertured, desiccant cannister sealably interfaced at one of said apertures to said air intake ports on said containment vessels, and said second aperture open to ambient air;
(c) a two chambered pump for synchronized pumping whilst providing isolated containment of each of the two-components of the adhesive, one chamber thereby dedicated per component, each of said chambers tubingly connected to each of said material output ports;
(d) a power supply for providing power to said pump and having an “on” and “off” state;
(e) a delivery gun for mixing the two-component adhesive for even distribution at the point of application; and
(f) wherein said second aperture is of a diameter sufficient to provide the influx of a necessary volume of air through said cannister(s) to accommodate the synchronized delivery of the two-component adhesive through the delivery gun when said power supply is in said “on” state.

2. The apparatus of claim 1, wherein said at least one dual-apertured desiccant canister comprises one cannister and said sealable interface comprises a “y” configuration, with each leg of the “y” interfaced to each of said air intake ports on each of said containment vessels.

3. The apparatus of claim 1, wherein said at least one dual-apertured desiccant canister comprises two dessicant cannisters one dedicated to each of the containment vessels, and said second aperture is of a diameter between 0.325 and 0.4 inches, and preferably 0.37 inches.

4. The apparatus of claim 1, wherein said two-component adhesive is a urethane.

5. The apparatus of claim 1, wherein said dessicant is selected from the group consisting of calcium sulfate and silica gel.

6. The apparatus of claim 1, wherein said dessicant cannister(s) further comprise a site glass for visibly revealing the saturation state of the desiccant.

7. The apparatus of claim 6, wherein said dessicant further comprises a state-changing material indicative of the water saturation of the dessicant contained therein.

8. The apparatus of claim 7, wherein said state-changing material is cobalt chloride.

9. The apparatus of claim 1, wherein said two chambered pump is a positive displacement rotary type metering pump.

10. The apparatus of claim 1, wherein said containment vessels are fifteen gallon drums.

11. A retrofit assembly for a push cart apparatus comprising a power supply powering a two-chambered pump for the metered delivery of a two-component adhesive and a delivery gun for mixing the two-components of the adhesive at the point of delivery, said push cart apparatus having an “on” state for delivery, comprising:
(a) two containment vessels for containing each of the components in isolation from one another, each such vessel comprising an air intake port and a material output port;
(b) at least one dual-apertured, desiccant cannister sealably interfaced at one of said apertures to said air intake ports on said containment vessels, and said second aperture open to ambient air;
(c) wherein said second aperture is of a diameter sufficient to provide the influx of a necessary volume of air through said cannister(s) to accommodate the synchronized delivery of the two-component adhesive through the delivery gun when said power supply is in said “on” state.

12. The apparatus of claim 11, wherein said at least one dual-apertured desiccant canister comprises one cannister and said sealable interface comprises a “y” configuration, with each leg of the “y” interfaced to each of said air intake ports on each of said containment vessels.

13. The apparatus of claim 11, wherein said at least one dual-apertured desiccant canister comprises two dessicant cannisters one dedicated to each of the containment vessels, and said second aperture is of a diameter between 0.325 and 0.4 inches, and preferably 0.37 inches.

14. The apparatus of claim 11, wherein said two-component adhesive is a urethane.

15. The apparatus of claim 11, wherein said dessicant is selected from the group consisting of calcium sulfate and silica gel.

16. The apparatus of claim 1, wherein said dessicant cannister(s) further comprise a site glass for visibly revealing the saturation state of the desiccant.

17. The apparatus of claim 16, wherein said dessicant further comprises a state-changing material indicative of the water saturation of the dessicant contained therein.

18. The apparatus of claim 17, wherein said state-changing material is cobalt chloride.

19. The apparatus of claim 1, wherein the two chambered pump is a positive displacement rotary type metering pump.

20. The apparatus of claim 1, wherein said containment vessels are fifteen gallon drums.
